(19) United States
(12) Patent Application Publication
(10) Pub. No.: US 2006/0226805 A1
(43) Pub. Date: Oct. 12, 2006

(54) Mobile battery-charging container

(76) Inventor: Tsung-I Yu, Pan Chiao (TW)

Correspondence Address: PAI PATENT & TRADEMARK LAW FIRM, 1001 FOURTH AVENUE, SUITE 3200, SEATTLE, WA, 98154, US

(21) Appl. No.: 11/105,118

(22) Filed: Apr. 11, 2005

(51) Int. Cl. H02J 7/00

(52) U.S. Cl. 320/107

(57) ABSTRACT

Disclosed is a mobile battery-charging container, which includes a container body for accommodating a mobile electronic device, a spare battery, for example, a primary or secondary battery mounted inside the container body, and a circuit board, which is mounted inside the container body and electrically connected to the spare battery and which has a terminal connectable to the mobile electronic device accommodated in the container body and a charging circuit for charging the battery of the mobile electronic device accommodated in the container body with the battery power of the spare battery through the terminal.

### BACKGROUND OF THE INVENTION

(a) Field of the Invention

The present invention relates generally to a container for carrying a mobile electronic device (for example, mobile phone, digital camera, PDA, or palm-top game machine) and more particularly, to a mobile battery-charging container, which automatically charges the battery of the carried mobile electronic device to the saturated status.

(b) Description of the Prior Art

Regular mobile electronic devices such as mobile phones, digital cameras, PDAs, palm-top game machines, etc., commonly use a rechargeable battery to provide the necessary working voltage. However, due to limited capacity, the power of the rechargeable battery of a mobile electronic device cannot provide much power for longtime operation. Therefore, the user of a mobile electronic device must regularly charge the battery of the mobile electronic device with a battery charger. When using a battery charger in a different country, the user must check the compatibility of the battery charger with the local city power outlet. To fit different electric outlets in different countries, different battery chargers shall be used.

### SUMMARY OF THE INVENTION

The present invention has been accomplished under the circumstances in view. According to one aspect of the present invention, the mobile battery-charging container comprises a container body, the container body comprising an accommodating chamber adapted to accommodate a mobile electronic device; at least one spare battery mounted inside the accommodating chamber of the container body; and a circuit board mounted inside the accommodating chamber and electrically connected to the spare battery, the circuit board comprising terminal means connectable to the mobile electronic device accommodated in the accommodating chamber of the container body and a charging circuit adapted to charge the mobile electronic device with the battery power of the at least one spare battery through the terminal means. Preferably, one high-capacity spare battery is used with at least one regular spare battery to provide sufficient standby power supply. According to another aspect of the present invention, the mobile battery-charging container is practical for charging a mobile telephone. When the user puts the mobile telephone in the container body, the charging circuit immediately charges the battery of the mobile telephone with the power of the spare battery, which can be a primary battery or secondary battery. Therefore, the battery of the mobile telephone is constantly maintained at a high level. According to still another aspect of the present invention, the container body can be made either of hard material or soft material in the form of a bag or box to fit a particular model of mobile electronic device, which can be a mobile phone, digital camera, PDA, or palm-top game machine. The container body can be an independent member convenient for the user to carry. Alternatively, the container body can be provided into a mobile personal item, for example, a suitcase, handbag, portfolio, travel bag, or the like. Further, the charging terminal of the circuit board can be made in any of a variety of types connectable to the matching terminal of a mobile electronic device through a plug joint, or by means of a contact connection or proximity induction. Further, the charging terminal can be made in the form of a cable connectable to the matching terminal of a mobile electronic device. According to still another aspect of the present invention, LED (or LCD) indicator means is provided to indicate the charging status of the charging circuit of the circuit board. According to still another aspect of the present invention, the spare battery is a secondary battery, and the circuit board further comprises a second charging circuit adapted to charge the spare battery with AC power supply. According to still another aspect of the present invention, the second charging circuit is used with a battery charger connectable to AC power supply. Further, the battery charger has an independent circuit board that controls charging of AC power supply to the spare battery in the container body.

### BRIEF DESCRIPTION OF THE DRAWINGS

FIG. 1 is a top plan view of a mobile battery-charging container according to the present invention, showing the circuit board fixedly mounted inside the accommodating chamber of the container body.

FIG. 2 is a side view of FIG. 1.

FIG. 3 is a schematic drawing of the present invention, showing the mobile battery-charging container suited with an AC adapter cable.

FIG. 4 is a schematic drawing showing the use of the mobile battery-charging container with a mobile phone according to the present invention (before connection of the mobile phone to the charging terminal).

FIG. 5 is a schematic drawing showing the use of the mobile battery-charging container with a mobile phone according to the present invention (after connection of the mobile phone to the charging terminal).

FIG. 6 is a schematic drawing showing an example of the connection between the charging terminal of the circuit board and the matching terminal of the mobile phone according to the present invention.

FIG. 7 is a schematic drawing showing another example of the connection between the charging terminal of the circuit board and the matching terminal of the mobile phone according to the present invention.

FIG. 8 is a schematic drawing showing still another example of the connection between the charging terminal of the circuit board and the matching terminal of the mobile phone according to the present invention.

FIG. 9 corresponds to FIG. 8 showing the mobile phone received inside the container body.

FIG. 10 is a schematic drawing showing the charging terminal made in the form of a cable.

FIG. 11 is similar to FIG. 10 but showing an alternate form of the connector of the cable.

FIG. 12 is a schematic drawing of the present invention showing proximity induction connection arrangement between the charging terminal and the mobile phone.

FIG. 13 is a schematic drawing of the present invention, showing the raised contacts of the charging terminal kept in contact with the respective recessed contacts of the matching terminal of the mobile phone.

FIG. 14 is a schematic drawing of the present invention, showing the electric socket of the charging terminal of the circuit board connected to the retractable plug of the mobile phone.

FIG. 15 is a schematic drawing of the present invention, showing one secondary battery provided at the bottom side inside the accommodating chamber of the container body.

FIG. 16 is a side view of FIG. 15.

FIG. 17 is a schematic drawing of the present invention, showing two pieces of secondary battery provided at two opposite lateral sides inside the accommodating chamber of the container body.

FIG. 18 is a schematic drawing of the present invention, showing four pieces of secondary battery symmetrically provided at two opposite lateral sides inside the accommodating chamber of the container body.

FIG. 19 is a schematic drawing of the present invention, showing one high-capacity secondary battery and two pieces of regular secondary battery arranged at two sides inside the accommodating chamber of the container body.

FIG. 20 is a schematic drawing of the present invention, showing one secondary battery removed out of the container body for a replacement.

FIG. 21 is a schematic drawing of the present invention, showing the mobile battery-charging container used with a digital camera.

FIG. 22 is a schematic drawing of the present invention, showing the mobile battery-charging container used with a palm-top game machine.

FIG. 23 is a block diagram showing charging of battery power from the secondary battery to the mobile electronic device's battery according to the present invention.

FIG. 24 is similar to FIG. 23 but showing the saturated status of the mobile electronic device's battery.

FIG. 25 is a schematic exploded view showing the mobile battery-charging container used with a battery charger according to the present invention.

FIG. 26 is similar to FIG. 25 but showing the battery charger provided with a circuit board for charging control.

FIG. 27 is similar to FIG. 26 but showing a proximity induction arrangement between the charging terminal of the mobile battery-charging container and the matching terminal of the battery charger.

FIG. 28 is a schematic drawing showing the mobile battery-charging container carried on the belt around the user's waist according to the present invention.

FIG. 29 is a schematic drawing showing the container body of the mobile battery-charging container provided inside a handbag.

FIG. 30 is a schematic drawing showing a spare battery formed of a primary battery according to the present invention.

FIG. 31 is a schematic drawing showing the spare battery formed of a primary battery and a secondary battery connected in parallel.

FIG. 32 is a schematic drawing showing the mobile battery-charging container provided with a cable connected and a mobile telephone connected to the cable and operated.

### DETAILED DESCRIPTION OF THE PREFERRED EMBODIMENTS

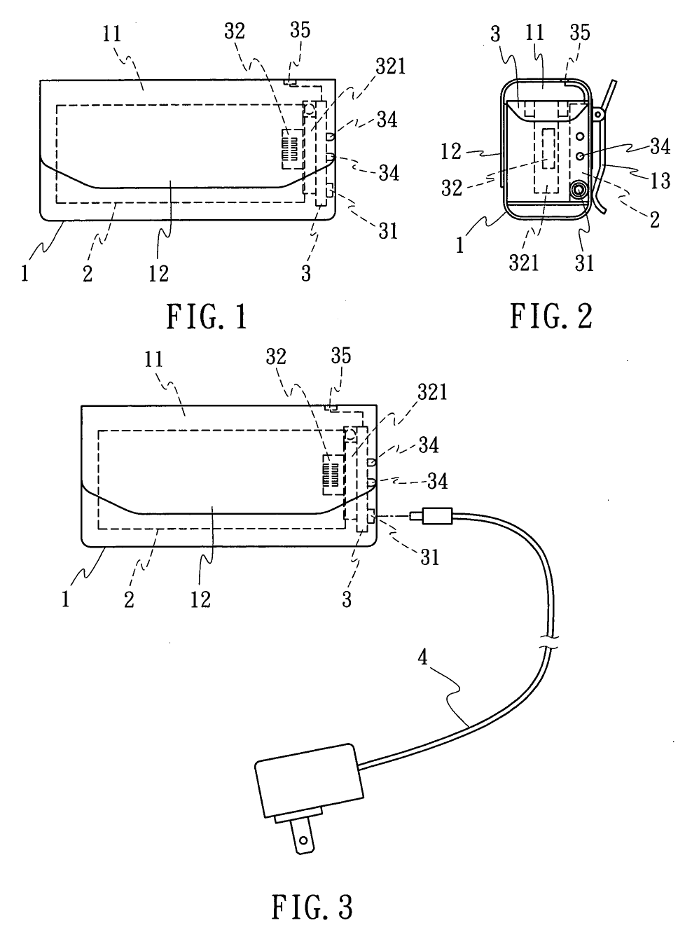

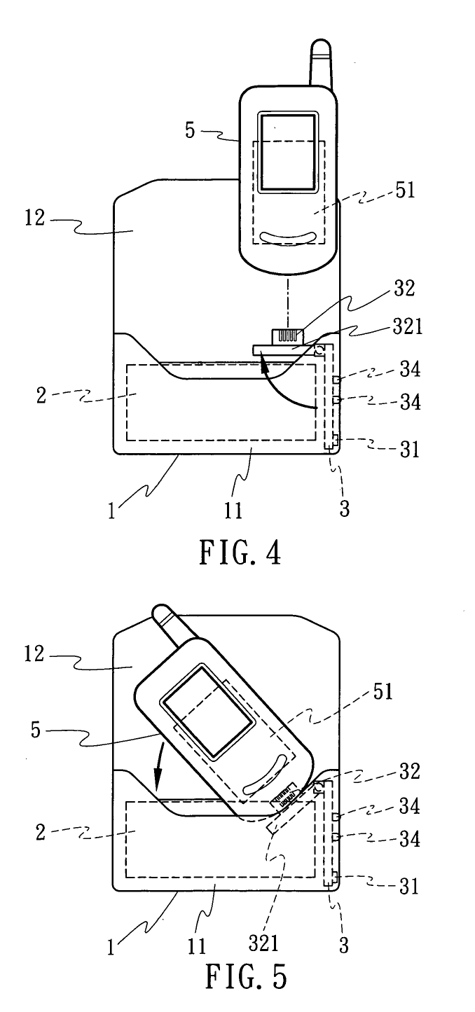

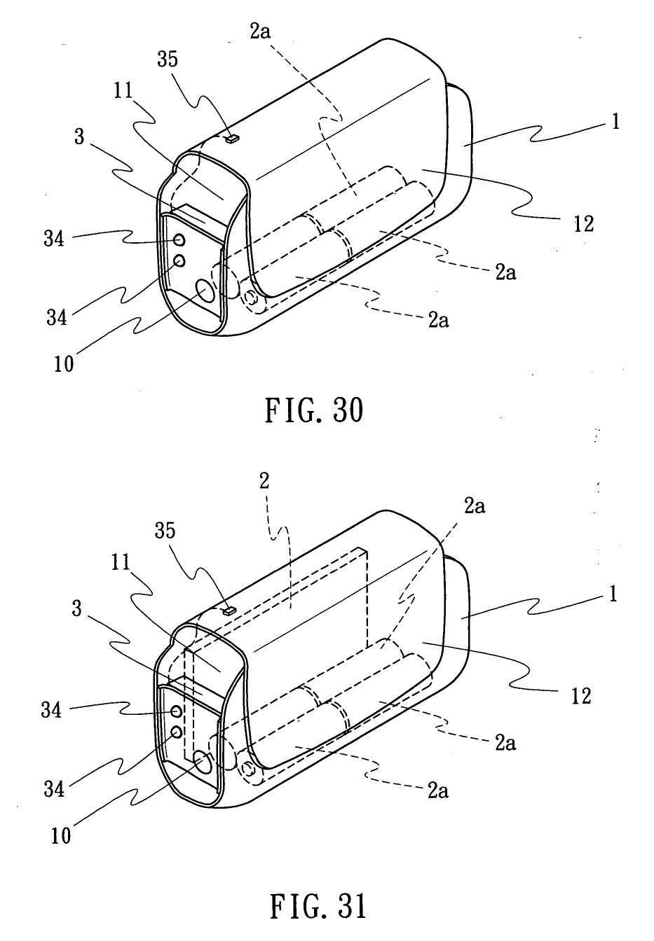

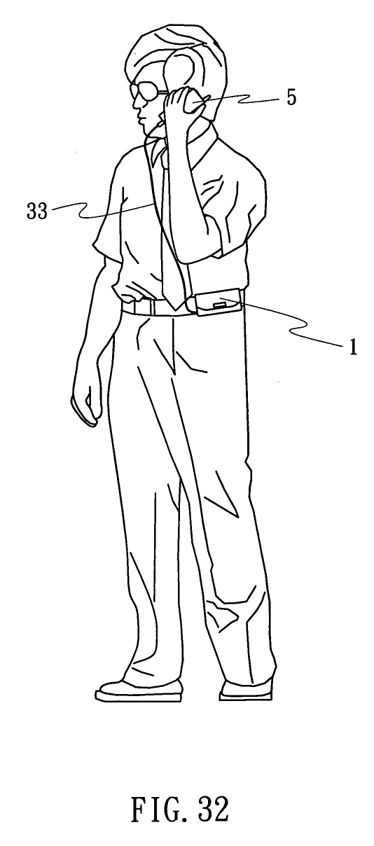

In the various embodiments shown in FIGS. 1˜29, a secondary battery is used as a spare battery. Actually, a primary battery 2a or secondary battery 2 may be selectively used. For example, the embodiment shown in FIG. 30 uses a primary battery 2a. FIG. 31 shows a design using a secondary battery 2 and a primary battery 2a.

Referring to FIGS. 1˜5, a mobile battery-charging container in accordance with the present invention is shown comprised of a container body 1, at least one secondary battery 2, and a circuit board 3.

The container body 1 can be made of either hard or soft material in the form of a bag or box, comprising an accommodating chamber 11 configured according to the mobile electronic device to be charged, a cover 12 adapted to close the accommodating chamber 11, and a clip 13 for fastening.

The secondary battery 2 is a high-capacity storage battery mounted inside the accommodating chamber 11 at a suitable location. The secondary battery 2 can be fixedly mounted inside the accommodating chamber 11. Alternatively, the secondary battery 2 can be detachably mounted inside the accommodating chamber 11 for easy replacement.

The circuit board 3 can be built in or detachably mounted inside the accommodating chamber 11 at a suitable location, having a charging circuit (not shown), a power input terminal 31 for receiving an AC adapter cable 4 (see FIG. 3), and a charging terminal 32 for connecting to a mobile electronic device, for example, mobile phone 5. The charging terminal 32 may be fixedly provided at the circuit board 3. Alternatively, a carrier plate 321 may be pivotally coupled to the circuit board 3 to hold the charging terminal 32, keeping the charging terminal 32 electrically connected to the circuit board 3. The carrier plate 321 can be turned in and out of the accommodating chamber 11 relative to the circuit board 3.

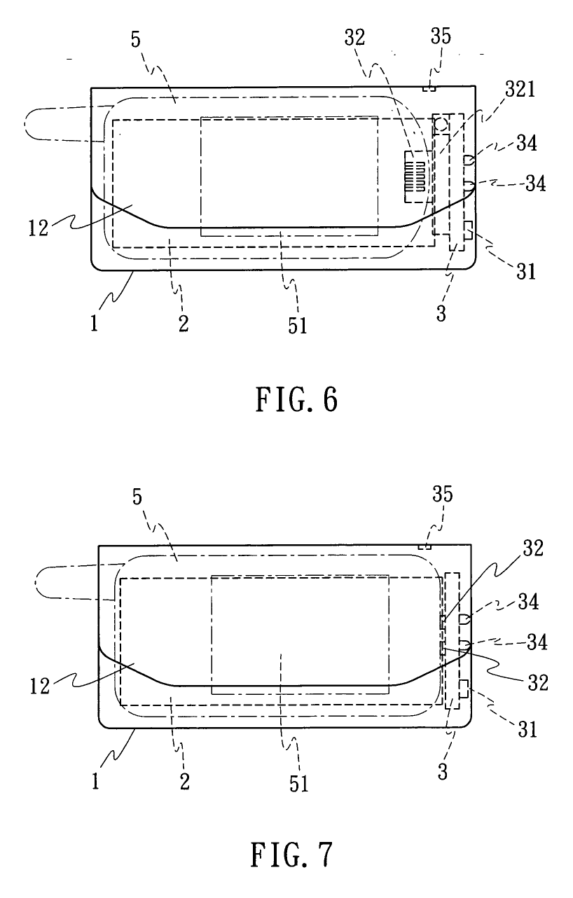

Referring to FIG. 6, the mobile battery-charging container can be made to carry and charge a mobile phone 5. Alternatively, the mobile battery-charging container can be made to carry and charge a digital camera, PDA, palm-top game machine, or any of a variety of small mobile electronic devices. After connection of the mobile electronic device, for example, mobile phone 5, to the charging terminal 32, the mobile phone 5 and the charging terminal 32 are set inside the accommodating chamber 11, and then the cover 12 is closed. When carrying the mobile battery-charging container, the charging circuit of the circuit board 3 charges the battery 51 of the mobile phone 5 with the battery power of the secondary battery 2 to the saturated status.

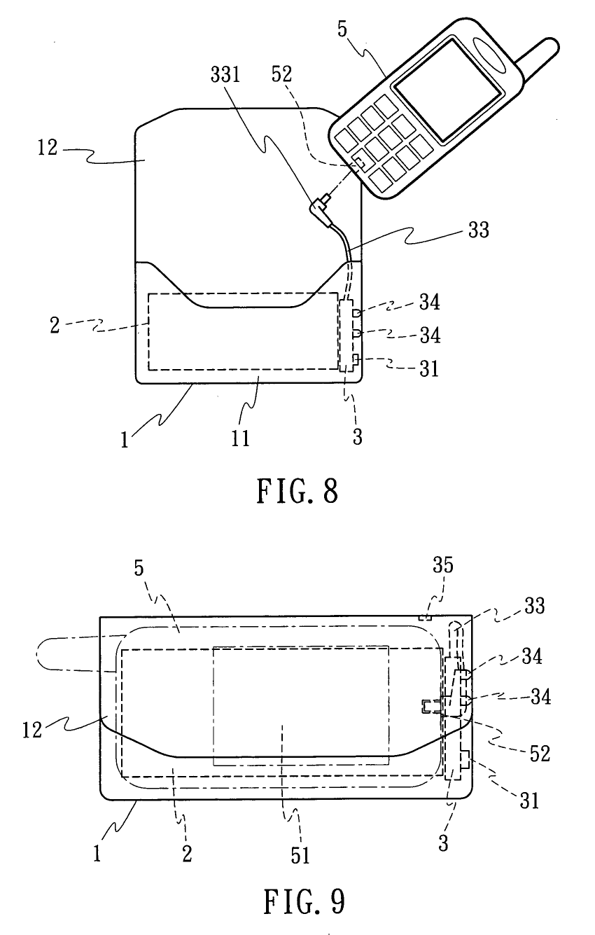

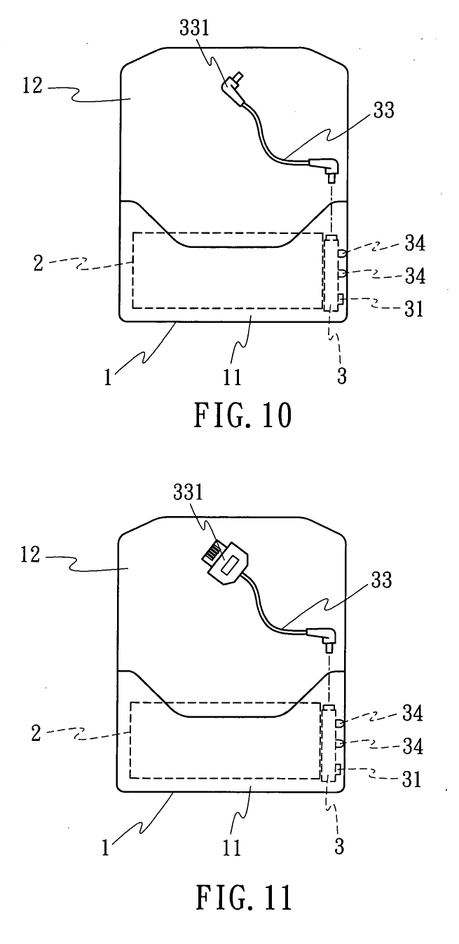

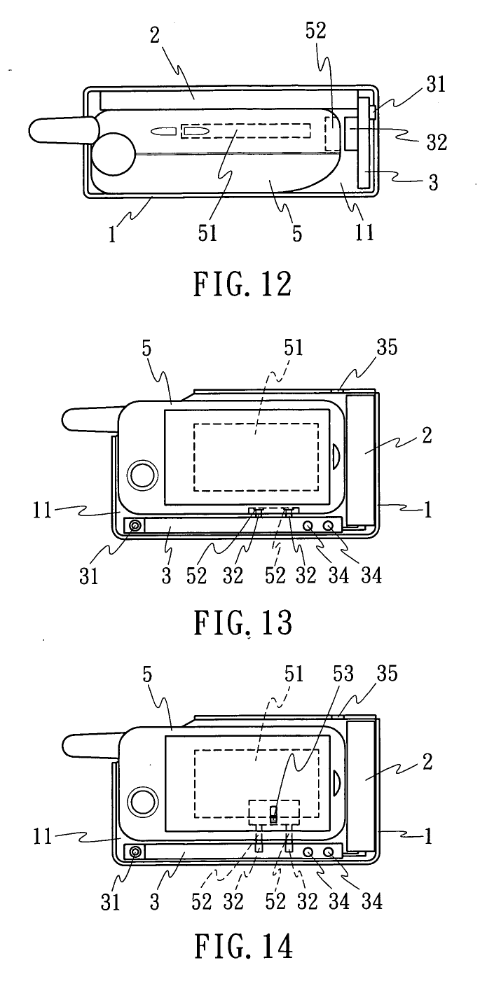

The charging terminal 32 of the circuit board 3 can be made connectable to the mobile electronic device 5 through a plug joint, or by means of contact connection or proximity induction. According to the embodiment shown in FIGS. 1˜6, the charging terminal 32 of the circuit board 3 is connectable to the mobile electronic device 5 through a plug joint. According to the embodiment shown in FIG. 7, the charging terminal 32 of the circuit board 3 has contacts for contacting the positive and negative contacts of the mobile electronic device 5. According to the embodiment shown in FIGS. 8 and 9, the charging terminal is a cable 33 extended from the circuit board 3 and terminating in an electric connector 331 connectable to the power input terminal 52 of the mobile electronic device 5. According to the embodiment shown in FIG. 10, the cable 33 is detachably connected to (a connector at) the circuit board 3. The embodiment shown in FIG. 11 is substantially similar to the embodiment shown in FIG. 10 with the exception of the type of the electric connector 331. According to the embodiment shown in FIG. 12, the charging terminal 32 of the circuit board 3 is electrically connectable to the power input terminal 52 of the mobile electronic device 5 through proximity induction, i.e., the charging terminal 32 of the circuit board 3 and the power input terminal 52 of the mobile electronic device 5 are respectively coupled to a proximity induction type charger.

As indicated above, the charging terminal 32 of the circuit board 3 and the power input terminal 52 of the mobile electronic device 5 can be made in any of a variety of forms to match each other. According to the embodiment shown in FIG. 13, the charging terminal 32 of the circuit board 3 is provided at the bottom side of the container body 1, having raised contacts respectively connectable to the recessed contacts of the power input terminal 52 of the mobile electronic device 5 for transmission of battery power from the secondary battery 2 to the battery 51 of the mobile electronic device 5. According to the embodiment shown in FIG. 14, the charging terminal 32 of the circuit board 3 is made in the form of a socket for receiving the retractable plug type power input terminal 52 of the mobile electronic device 5 for transmission of battery power from the secondary battery 2 to the battery 51 of the mobile electronic device 5.

In the aforesaid various embodiments shown in FIGS. 1˜14, indicator lights (LEDs) 34 are installed in the circuit board 3 and exposed to the outside of the container body 1 to indicate the charging action or the saturated status, and a battery low indicator light (LED) 35 is installed in the circuit board 3 and exposed to the outside of the container body 1 and adapted to give off light when the power of the secondary battery 2 is low.

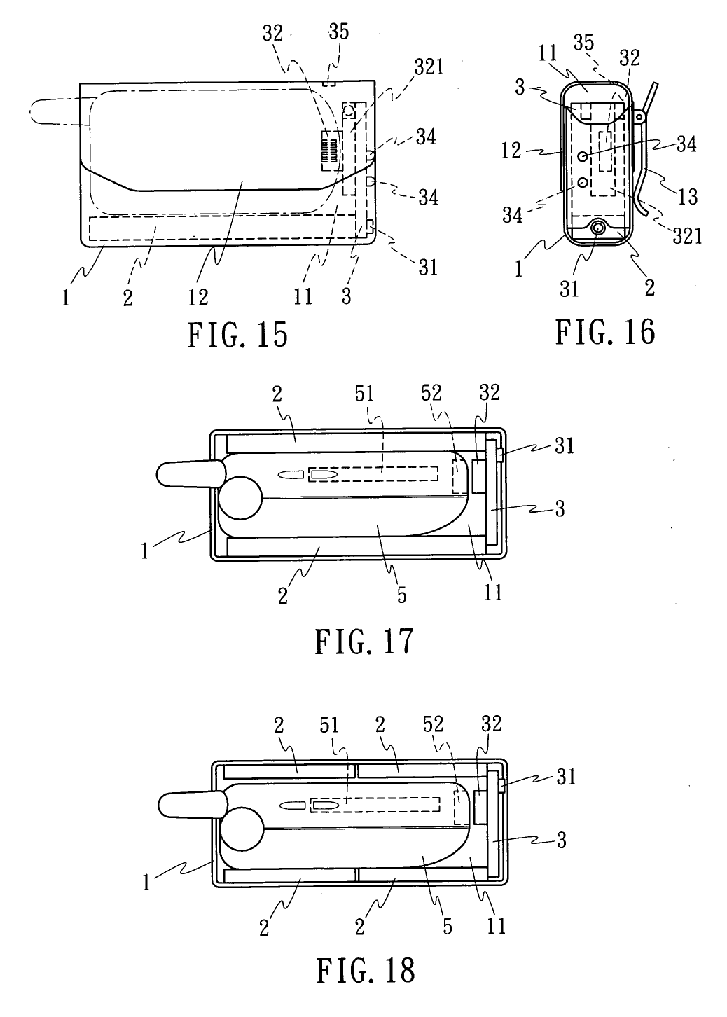

According to the design of the present invention, the secondary battery 2 is joined to the inside of the accommodating chamber 11 of the container body 1 at a suitable location. According to the embodiment shown in FIGS. 15 and 16, one secondary battery 2 is mounted inside the accommodating chamber 11 of the container body 1. According to the embodiment shown in FIG. 17, two pieces of secondary battery 2 are bilaterally mounted inside the accommodating chamber 11 of the container body 1. According to the embodiment shown in FIG. 18, four pieces of secondary battery 2 are symmetrically arranged at two sides inside the accommodating chamber 11 of the container body 1. According to the embodiment shown in FIG. 19, three pieces of secondary battery 2 are bilaterally mounted inside the accommodating chamber 11 of the container body 1, i.e., two pieces of secondary battery at one lateral side inside the accommodating chamber 11 of the container body 1 and one high-capacity secondary battery at the other lateral side inside the accommodating chamber 11 of the container body 1.

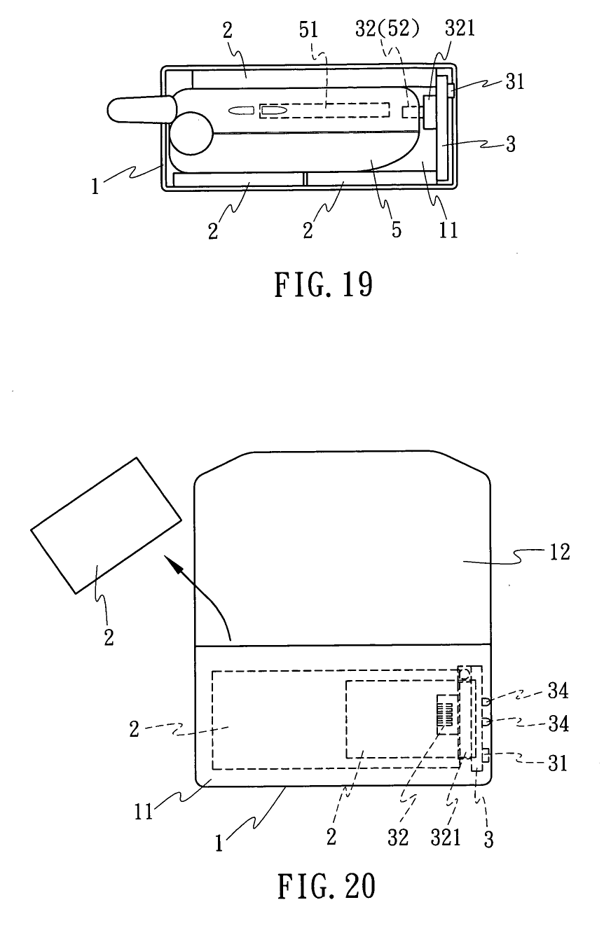

According to the embodiment shown in FIG. 20, the secondary battery 2 is detachably mounted inside the accommodating chamber 11 of the container body 1 for easy replacement. Preferably, the secondary battery 2 is of the same model as the battery 51 of the mobile electronic device 5 so that the secondary battery 2 can be used in the mobile electronic device 5 to replace the battery 51.

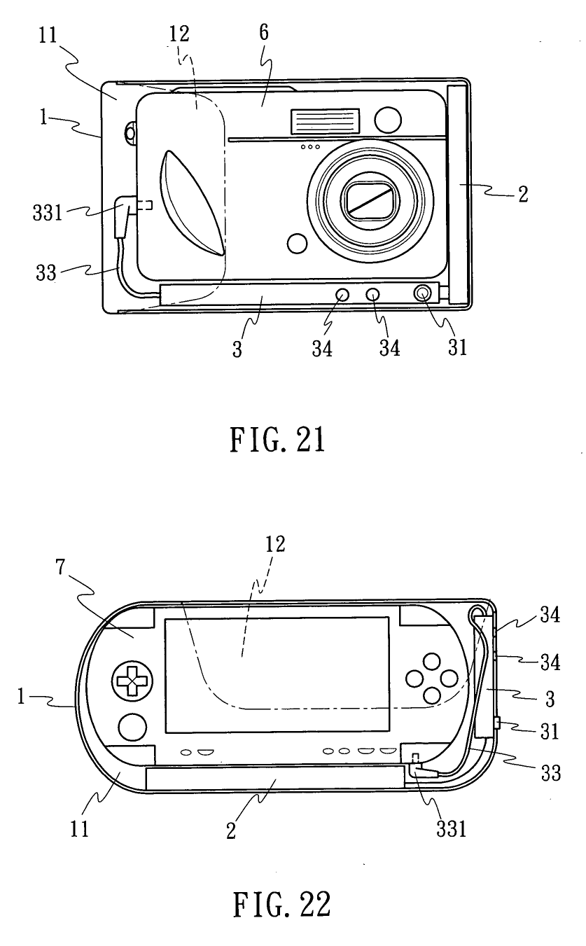

According to the embodiment shown in FIG. 21, the mobile battery-charging container is adapted to carry and charge a digital camera 6. According to the embodiment shown in FIG. 22, the mobile battery-charging container is adapted to carry and charge a palm-top game machine 7. Further, the container body 1 of the mobile battery-charging container can be made in the form of an independent member. Alternatively, the container body 1 of the mobile battery-charging container can be formed integral with a suitcase, handbag, portfolio, travel bag, or any of a variety of portable personal apparatus.

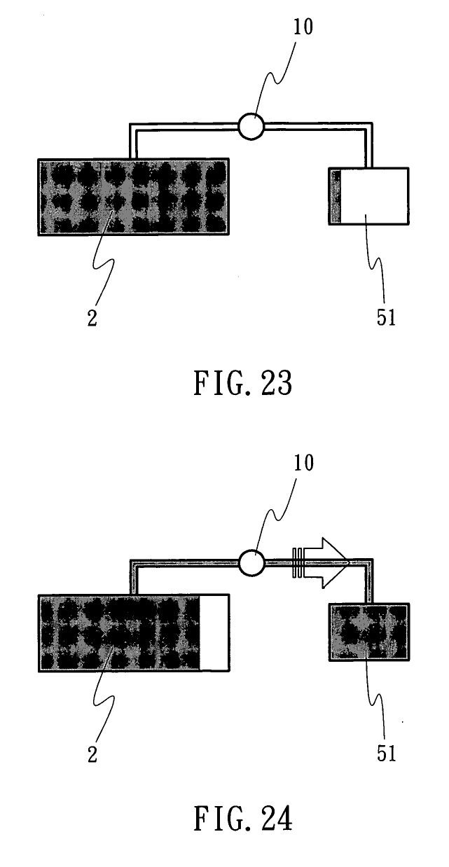

According to the design principle of the present invention, the mobile battery-charging container charges the battery 51 of the mobile electronic device 5 with the battery power of the secondary battery 2 from a battery low status shown in FIG. 23 to the saturated status shown in FIG. 24.

In actual practice, the circuit board 3 can be made having a first charging circuit for charging the battery 51 of the mobile electronic device 5 with the battery power of the secondary battery 2, and a second charging circuit for charging the secondary battery 2 with external power supply, for example, AC power supply. When the battery 51 of the mobile electronic device 5 reached the saturated status, the respective indicator light (LED) 34 is turned on to give an indication. Further, an On/Off switch 10 (see FIGS. 23˜27) may be installed in the container body 1 at a suitable location and electrically connected to the first charging circuit for manually switching off the first charging circuit after the battery 51 of the mobile electronic device 5 has been charged to the saturated status. The second charging circuit can be made comprising a voltage stabilizer and protector circuit and a transformer for charging the secondary battery 2 with AC power supply. Indicator light means may be installed to indicate the charging status of the second charging circuit.

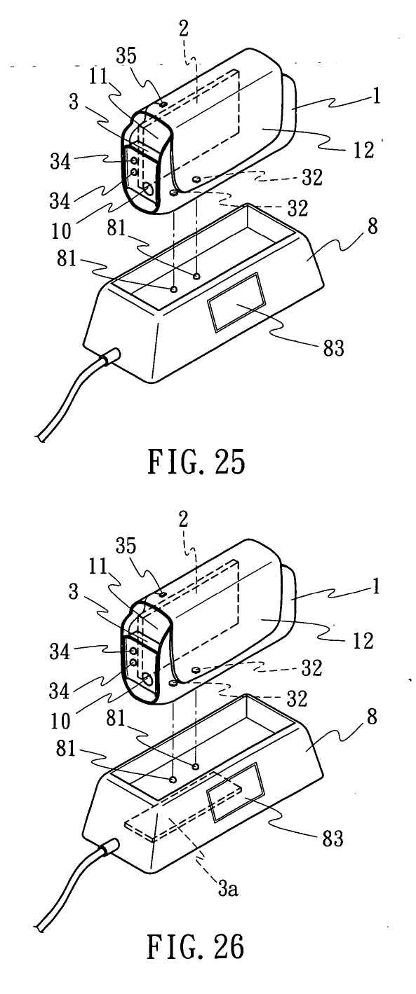

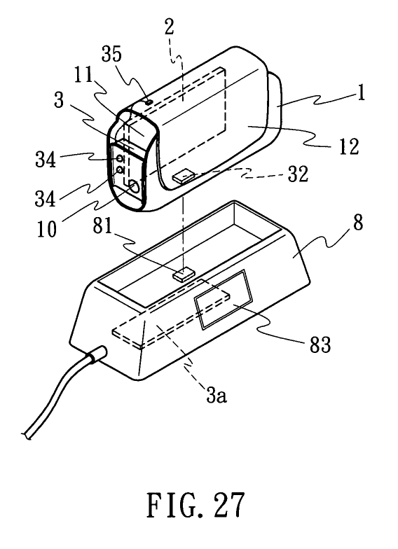

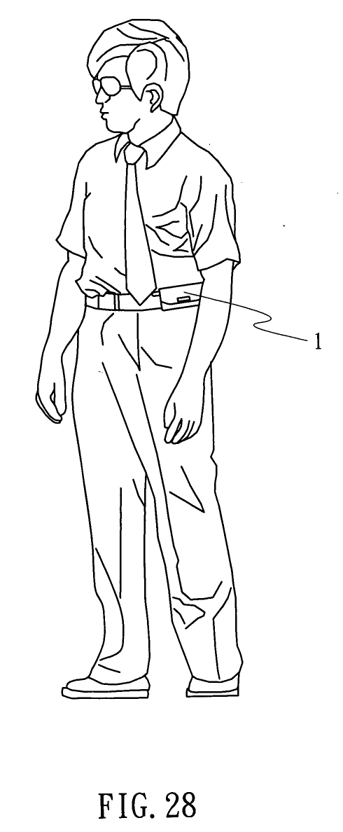

Referring to FIGS. 25˜27, the container body 1 of the mobile battery-charging container is made insertable into a battery charger 8. The battery charger 8 comprises a liquid crystal display screen 83 for indication of charging status, and a charging terminal 81 for connection to the charging terminal 32 of the circuit board 3 of the mobile battery-charging container. The charging terminal 81 can be made in any of a variety of forms matching the charging terminal 32 of the circuit board 3. Further, the battery charger 8 has an independent circuit board 3a that controls the charging operation of the battery charger 8.

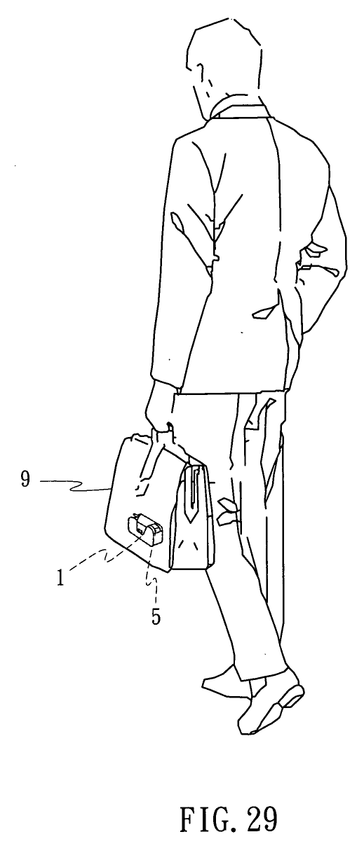

FIG. 28 shows an application example of the present invention, where the mobile battery-charging container is carried on the belt around the user's waist. FIG. 29 shows another application example of the present invention, where the mobile battery-charging container is provided inside a handbag 9.

Further, in actual practice, a primary battery 2a may be substituted for the secondary battery 2. For example, in the embodiment shown in FIG. 30, a #3 or #4 or other model of primary battery (dry battery) is used and electrically connected to the circuit board 3. According to this design, the circuit board 3 needs only one charging circuit (the spare primary battery 2a is not connectable to city power supply), and the primary battery 2a is used to charge the battery 51 of the mobile electronic device 5. According to the embodiment shown in FIG. 31, a secondary battery 2 and a primary battery 2a coexist in the container body 1. When the secondary battery 2 is low, the primary battery 2a provides power for charging the battery 51 of the mobile electronic device 5.

Further, in the embodiments shown in FIGS. 8˜11, the cable 33 extends from the circuit board 3 and terminates in an electric connector 331 connectable to the power input terminal 52 of the mobile electronic device 5. This design allows the user to take the mobile electronic device (mobile telephone) 5 out of the container body 1 for use while remaining electrically connected to the circuit board 3.

A prototype of mobile battery-charging container has been constructed with the features of FIGS. 1˜31. The mobile battery-charging container functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A mobile battery-charging container comprising:
a container body, said container body comprising an accommodating chamber adapted to accommodate a mobile electronic device;
at least one spare battery mounted inside said accommodating chamber of said container body; and
a circuit board mounted inside said accommodating chamber and electrically connected to said at least one spare battery, said circuit board comprising terminal means connectable to the mobile electronic device accommodated in said accommodating chamber of said container body and a charging circuit adapted to charge the mobile electronic device with the battery power of said at least one spare battery through said terminal means.

2. The mobile battery-charging container as claimed in claim 1, wherein said spare battery is a secondary battery.

3. The mobile battery-charging container as claimed in claim 1, wherein said spare battery is a primary battery.

4. The mobile battery-charging container as claimed in claim 1, wherein said spare battery comprises a primary battery and a secondary battery connected in parallel.

5. The mobile battery-charging container as claimed in claim 1, wherein said circuit board is detachably mounted inside said accommodating chamber of said container body.

6. The mobile battery-charging container as claimed in claim 1, further comprising clip means provided outside said container body for fastening.

7. The mobile battery-charging container as claimed in claim 1, wherein said circuit board further comprises a power input terminal for receiving an AC adapter cable for charging said at least one spare battery with AC power supply.

8. The mobile battery-charging container as claimed in claim 1, wherein the charging terminal of said circuit board is connectable to a matching terminal of a mobile electronic device through a plug joint.

9. The mobile battery-charging container as claimed in claim 1, wherein the charging terminal of said circuit board is connectable to a matching terminal of a mobile electronic device by means of a contact connection.

10. The mobile battery-charging container as claimed in claim 1, wherein the charging terminal of said circuit board is connectable to a matching terminal of a mobile electronic device by means of proximity induction.

11. The mobile battery-charging container as claimed in claim 1, wherein said charging terminal is a cable.

12. The mobile battery-charging container as claimed in claim 11, wherein said cable has an electric connector disposed at one end thereof and connectable to a matching terminal of a mobile electronic device.

13. The mobile battery-charging container as claimed in claim 1, wherein said charging terminal comprises raised positive pole and negative pole contacts for contacting recessed positive pole and negative pole contacts of a matching terminal of a mobile electronic device.

14. The mobile battery-charging container as claimed in claim 1, wherein said charging terminal is made in the form of an electric socket for receiving a retractable plug type matching terminal of a mobile electronic device.

15. The mobile battery-charging container as claimed in claim 1, wherein said at least one spare battery is detachably mounted in said accommodating chamber of said container body.

16. The mobile battery-charging container as claimed in claim 1, wherein said container body is made in the form of a bag.

17. The mobile battery-charging container as claimed in claim 1, wherein said container body is made in the form of a box.

18. The mobile battery-charging container as claimed in claim 1, wherein said container body is formed integral with a mobile personal item.

19. The mobile battery-charging container as claimed in claim 1, wherein said circuit board further comprises a second charging circuit adapted to charge said at least one spare battery with AC power supply.

20. The mobile battery-charging container as claimed in claim 19, wherein said second charging circuit is used with a battery charger connectable to AC power supply.

21. The mobile battery-charging container as claimed in claim 20, wherein said battery charger has a circuit board that controls the charging operation of providing charging power supply to said at least one spare battery through said second charging circuit.

22. The mobile battery-charging container as claimed in claim 20, wherein said second charging circuit is electrically connectable to said battery charger through a plug joint.

23. The mobile battery-charging container as claimed in claim 20 wherein said second charging circuit is electrically connectable to said battery charger by means of a contact connection.

24. The mobile battery-charging container as claimed in claim 20, wherein said second charging circuit is electrically connectable to said battery charger by means of proximity induction.
